(19) United States
(12) Patent Application Publication
(10) Pub. No.: US 2010/0063883 A1
(43) Pub. Date: Mar. 11, 2010

(54) Financial donation system and method thereof

(76) Inventor: Thuang Jzin Teng, Costa Mesa, CA (US)

Correspondence Address: DAVID AND RAYMOND PATENT FIRM, 108 N. YNEZ AVE., SUITE 128, MONTEREY PARK, CA, 91754, US

(21) Appl. No.: 12/231,782

(22) Filed: Sep. 5, 2008

(51) Int. Cl. G06Q 40/00; G06Q 30/00

(52) U.S. Cl. 705/14.66; 705/39; 705/30; 705/14.7

(57) ABSTRACT

A financial donation method includes the steps of (a) providing a community platform for interactively linking among a plurality of supporters, a plurality of participating merchants, and a plurality of membership recipients, wherein each of the supporters is able to select one or more membership recipients as a designated recipient; (b) voluntarily changing a living habit of each of the supporters to have a financial transaction with one of the participating merchants; and (c) contributing a predetermined amount of affiliate commissions, based on an amount of the financial transaction, from the participating merchant to the designated recipient through the community platform.

### BACKGROUND OF THE PRESENT INVENTION

1. Field of Invention

The present invention relates to donation, and more particularly to a financial donation system and method thereof which is capable of facilitating convenient and rapid donation for the assistance of those who have been diagnosed as having autism.

2. Description of Related Arts

1 in every 150 children born in the U.S. is diagnosed with autism (The Center for Disease Control, CDC), making it more common than pediatric cancer, diabetes, and AIDS combined. It costs $3.2 million to support an autistic individual during his lifespan (Harvard School of Public Health, 2006). This places tremendous burden on the autistic child, the parents' marriage, the family, community and this nation.

Thus, the disease places tremendous burdens on the child, his or her family, the community in which the child resides, and the entire nation as a whole. Those families having autistic children need paying extra attention and care to the relevant children and this often severely affect the normal daily lives of their parents. For example, the parents of autistic children may need to stay home for an extended period of time in order to take care of their children. In other words, they may not, as others do, go to work or engage in any other social or commercial activities.

Because of this prevalent phenomenon, those families having autistic children may receive donation of funds from some sorts of charities or local government. People may donate to charitable organizations and these organizations then collect all the donation income and distribute it to those who are in need. These organizations are usually regulated by explicit rules and regulations and are run and managed by independently-appointed trustees. There are, however, several disadvantages in relation to this traditional donation model.

First, traditional fundraising model for autistic children does not allow the donor to communicate with the ultimate recipient of the money. As a matter of fact, most donors do not even know where their money goes. They can only trust the organizations for prompt and effective distribution of their donation money to those who are in need.

Second, under traditional donation model, the operating cost of the charitable organizations is usually funded by a portion of all the donation money, plus some subsidiary from the federal or municipal government. As a result, fellow donors would have to expect that at least some portions of their money will be used to compensate the operating or administrative cost of the charitable organizations involved. However, the donor may never know the exact percentage of their donated money which will go to cover the operating or administrative cost of the charitable organizations. Generally speaking, individual donors do not have a realistic right to object to the distribution of the donated money or the percentage thereof which may go to cover up the administrative cost of the charitable organizations. There may exist some procedures for making complaints, but these are usually so highly complicated that individual donors may lack the necessary resources and time to deal with the corresponding charitable organizations. Practically, therefore, individual donors are often left with the unfair choice of either completely relying on the management of the relevant charitable organization, or giving up his or her wish to donate altogether.

Third, with respective to autism, traditional donation model does not assist in the recovery of the children concerned apart from the provision of the necessary financial resources for their families and the related medical expenses. As a result, there is nothing in traditional donation model to directly assist the recovery of the autistic children. As a matter of fact, virtually all donors do not even know the recipients of their donated money. Yet most autistic children, apart from medical assistance, require frequent and comprehensive care programs in order to have a prompt or at least significant progress to recovery. One of these care programs may be carefully-tailored communication sessions. These communication sessions may be formal or informal in nature, yet for most traditional donation models, little have been done to assist the autistic children by extending their assistance to cover other assistance programs apart from the mere provision of limited financial resources, or to encourage the recipient to perform some actions which are capable of helping them during their recovery journey.

### SUMMARY OF THE INVENTION

A main object of the present invention is to provide a financial donation system and method thereof which is capable of facilitating convenient and rapid donation for the assistance of those who have been diagnosed as having autism or any other predetermined special needs.

Another object of the present invention is to provide a financial donation system and method thereof which is capable of bringing together merchants, families with autism and community into a win-win-win relationship. In other words, families with autism are able to receive sufficient financial and comprehensive supportive service. Participating merchants are able to receive a significant amount of benefits in participating into the method of the present invention. Moreover, individual donors are able to establish a long-term relationship with families with autism, and support those families with adequate financial resources.

Another object of the present invention is to provide a financial donation system and method thereof, wherein individual donors are capable of identifying the recipient of the financial resources and assisting with the recovery progress of the designated recipient.

Another object of the present invention is to provide a financial donation system and method thereof, wherein participating merchants are allowed to gain income through enhanced advertisements while promoting donation for autism families. In other words, participating merchants would have adequate incentives for carrying out the method of the present invention.

Another object of the present invention is to provide a financial donation system and method thereof which is capable of voluntarily changing a living habit of each of the supporters to have a financial transaction with one of the participating merchants so as to provide incentive for participating merchants to carry out the method of the present invention while allowing the supporters to effectuate their desire to help autistic families.

Another object of the present invention is to provide a financial donation system and method thereof which is capable of providing a spiritual and financial support for the autistic families during the recovery journey thereof.

Accordingly, in order to accomplish the above objects, the present invention provides a financial donation method, comprising the steps of:

(a) providing a community platform for interactively linking among a plurality of supporters, a plurality of participating merchants, and a plurality of membership recipients, wherein each of the supporters is able to select one or more membership recipients as a designated recipient;

(b) voluntarily changing a living habit of each of the supporters to have a financial transaction with one of the participating merchants; and

(c) contributing a predetermined amount of affiliate commissions, based on an amount of the financial transaction, from the participating merchant to the designated recipient through the community platform.

Moreover, the present invention provides a financial donation system, comprising:

a community platform for interactively linking among the supporters, a plurality of participating merchants, and a plurality of membership recipients through Internet, wherein the community platform comprises a designated forum for each of the supporters to select one or more membership recipients as a designated recipient;

a charity database containing information of the participating merchants for the supporters to overview thereof to encourage each of the supporters to voluntarily change a living habit of the supporter to have a financial transaction with one of the participating merchants as a designated merchant; and

a financial center receiving a predetermined amount of affiliate commissions, based on an amount of the financial transaction, from the participating merchant to the designated recipient through the community platform.

These and other objectives, features, and advantages of the present invention will become apparent from the following detailed description, the accompanying drawings, and the appended claims.

### BRIEF DESCRIPTION OF THE DRAWINGS

FIG. 1 is a flow chart of a financial donation method according to a preferred embodiment of the present invention.

FIG. 2 is a schematic diagram of a financial donation system according to the above preferred embodiment of the present invention, wherein the system employs the financial donation method described above.

FIG. 3 is a schematic diagram of a declaration of the designated recipient according to the above preferred embodiment of the present invention.

FIG. 4 is a schematic diagram of the community platform according to the above preferred embodiment of the present invention.

### DETAILED DESCRIPTION OF THE PREFERRED EMBODIMENT

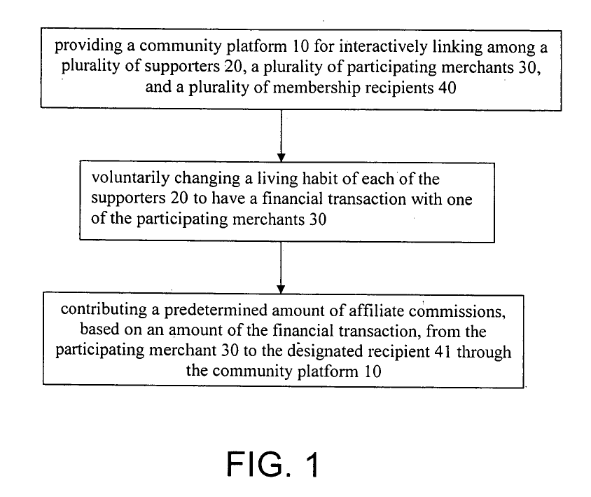

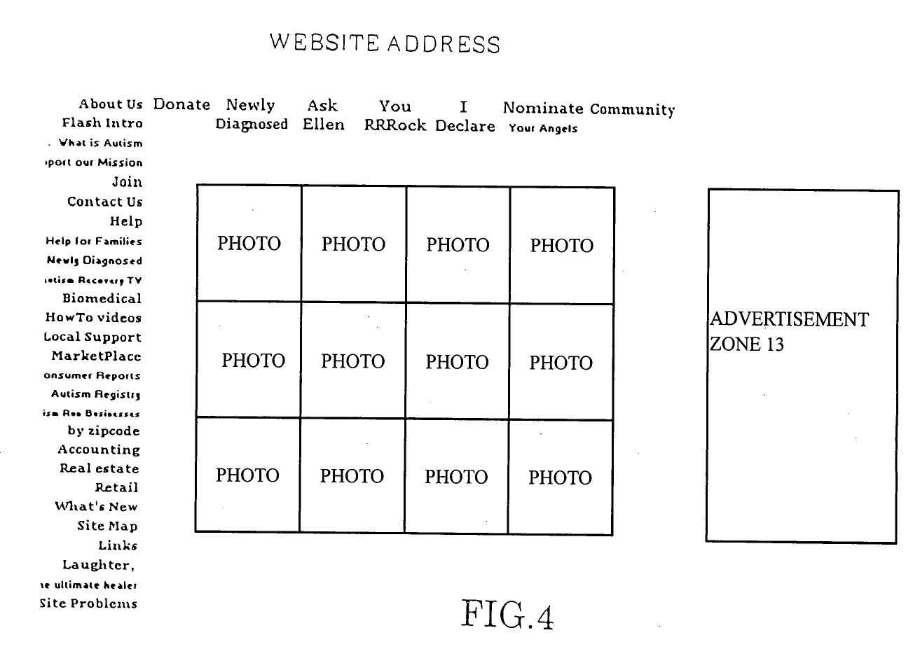

Referring to FIG. 1 to FIG. 4 of the drawings, a financial donation method according to a preferred embodiment of the present invention is illustrated, in which the method comprises the steps of:

(a) providing a community platform 10 for interactively linking among a plurality of supporters 20, a plurality of participating merchants 30, and a plurality of membership recipients 40 with special needs, wherein each of the supporters 20 is able to select one or more membership recipients 40 as a designated recipient 41, wherein the designated recipient 41 is an autistic child or a family having an autistic child;

(b) voluntarily changing a living habit of each of the supporters 20 to have a financial transaction with one of the participating merchants 30; and

(c) contributing a predetermined amount of affiliate commissions, based on an amount of the financial transaction, from the participating merchant 30 to the designated recipient 41 through the community platform 10.

In step (a), each of the supporters 20 can be a registered supporter 20 of the community platform 10 who is willing to make a financial contribution to the designated recipient 41 through business transaction with the participating merchants 30, or a general supporter who is not willing to register with the community platform 10 but yet is willing to support the membership recipient 40 through conducting business transactions with the participating merchants 30. Moreover, the recipients 40 should have a corresponding special need in order to receive the affiliate commission. For example, the recipients 40 may have autism as the special need for receiving the financial aid from the supporter 20. Alternatively, the special need may embrace many other special circumstances such as earthquake victims, Parkinsons syndrome (cancers, breast cancer, leukemia, childhood cancers, Down's Syndrome or other diseases) sufferers, or even for those who are financially challenged (Single parents, graduate students, musical scholars etc.).

In other words, the supporters 20 are divided into a group of registered supporters who are willing to financially contribute to the membership recipients through financial transactions with the participating merchants 30 and are registered with the community platform 10, and a group of general supporters who are not registered with the community platform 10 yet are willing to financially contribute to the membership recipients 30, wherein only the registered supporters are able to designate a particular membership recipient 40 as the designated recipient 41.

According to the preferred embodiment of the present invention, step (a) further comprises a step of creating a spiritually supportive environment in the community platform 10 by the designated recipient 41 to make a declaration of a goal for self-improvement and inspiration, and an effort being undertaken, such that the designated recipient 41 receives a special prize from the participating merchant 30 or the corresponding supporter 20 of the goal and effort is made. It is worth mentioning that the goal for self-improvement and inspiration needs not be aggressively defined in order for the designated recipient 41 to be given the special prize from the participating merchants 30 or the corresponding supporter 20. The goal and efforts are of general rehabilitative or therapeutic nature, and preferably set in small increments. For example, the designated recipient 41 may be required to take only specified or special diets which are specifically designed to relieve the symptoms of autism. As time passes, the special diets may be able to help the designated recipient 41 to have certain degree of improvement toward rehabilitation. Alternatively, the goal may be the performance of certain exercises for the benefits of the designated recipient 41.

In step (c), the designated recipient 41 receives 100% of the affiliate commissions from the participating merchants 30 such that the community platform 10 make no profit from the affiliate commissions while the supporters 20 participate in cashless charity. In other words, the supporters 20 do not need to pay extra for contributing to the affiliate commissions. Rather, the supporters 20 merely need to change their living habits (preferably their shopping habits) by shopping in the participating merchants 30. The cashless charity is therefore defined by the phenomenon that each of the supporters 20 are not required to pay ‘cash’ to directly donate to the designated recipient 41.

In order to enhance the interaction between the supporters 20 and the designated recipient 41 with a view to improve his or her autistic condition, step (a) further comprises a step of providing a communication center 12 for the corresponding supporter 20 to communicate with the designated recipient 41 through Internet. The communication center 12 is preferably embodied as a specific webpage provided by the community platform 10 for facilitating messaging delivery between the designated recipient 41 and the corresponding supporter 20, or even supporting real time interaction between the designated recipient 41 and the corresponding supporter 20. With the aid of the communication center 12, the designated recipient 41 is expected to have his or her autistic condition improved or to receive goodwill message from the corresponding supporter 20 through some forms of interaction between the designated recipient 41 and corresponding supporter 20 through the communication center 12.

In order to keep track of the total amount of affiliate commissions paid by the participating merchants 30 or received by the designated recipient 41. The financial donation method further comprises a step of creating a charity record for each of the designated recipients 41 to show the financial transactions made by the supporters 20 and the affiliate commissions contributed from the participating merchants 30.

Moreover, in order to provide incentive to the participating merchants 30 for carrying out the method of the present invention, step (c) further comprises a step of paying a predetermined amount of advertising fee from the participating merchant 30 to the community platform 10 such that a corresponding advertisement of the participating merchant 30 is shown on the community platform 10 every time when the supporters 20 and designated recipients 41 access the community platform 40 through Internet. As such, the products or services of the participating merchants 30 can be widely advertised and promoted through the community platform 10, which in turn may increase the sales volume of the corresponding participating merchants 30 and therefore the affiliate commissions. In other words, the advertisements not only help to boost up the sales of the participating merchants, but also indirectly increase the donation payable to the designated recipient 41.

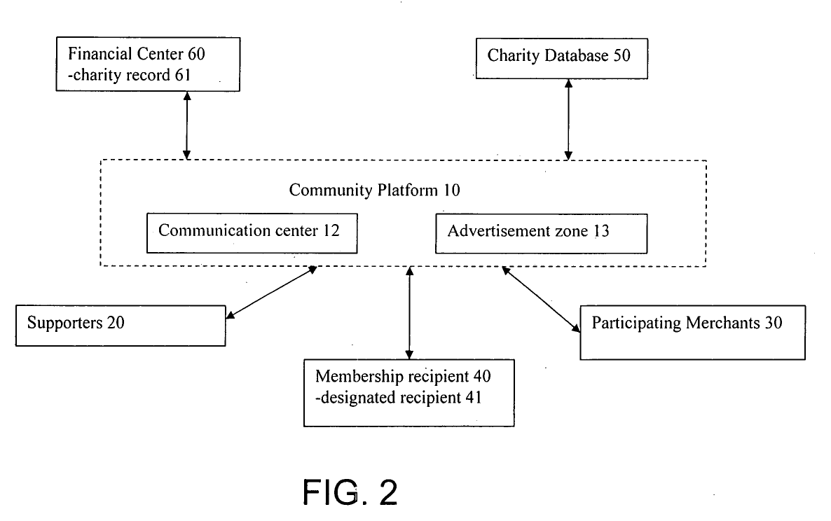

Referring to FIG. 2 to FIG. 4 of the drawings, a financial donation system according to the preferred embodiment of the present invention is illustrated, in which the financial donation system comprises the community platform 10, a charity database 50, and a financial center 60.

The community platform 10 is for interactively linking among the supporters 20, the plurality of participating merchants 30, and the plurality of membership recipients 40 through Internet, wherein the community platform 10 comprises a designated forum for each of the supporters 20 to select one or more membership recipients 40 as a designated recipient 41. The designated recipient 41 is registered to the community platform 10 that the designated recipient 41 is an autistic child or a family having an autistic child. As such, the special need may be defined as having suffered from autism.

The charity database 50 contains information of the participating merchants 30 for the supporters 20 to overview thereof so as to encourage each of the supporters 20 to voluntarily change a living habit of the supporter 20 to have a financial transaction with one of the participating merchants 30 as a designated merchant.

The financial center 60 is arranged to receive a predetermined amount of affiliate commissions, based on an amount of the financial transaction, from the participating merchant 30 to the designated recipient 41 through the community platform 10. The affiliate commission is payable to the designated recipient 41 as donation from the supporters 20. Therefore, the financial center 60 is arranged to manage the affiliate commissions to directly deposit 100% of the affiliate commissions to the designated recipient 41 in such a manner that the supporters 20 participate in cashless charity in the sense that no donation money is directly taken out from the supporters' 20 pocket as cash.

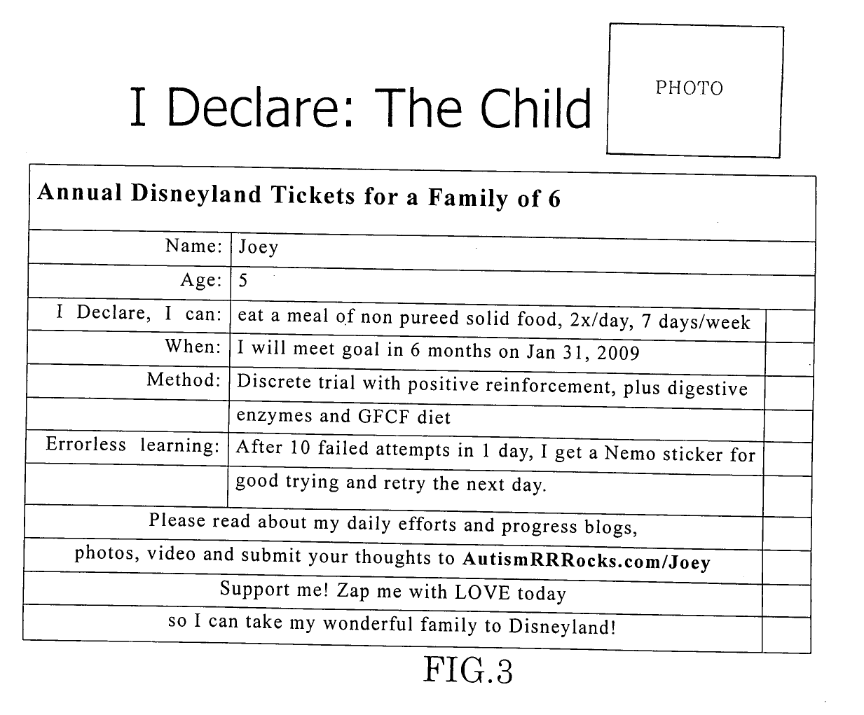

The community platform 10 further contains a spiritually supportive environment created by the designated recipient 41 to make a declaration of a goal for self-improvement and inspiration, and an effort being undertaken, such that the designated recipient 41 receives the affiliate commissions from the participating merchant 30 until the goal and effort is made. An example of the declaration is shown in FIG. 3, where the child declares that he can eat a meal of non pureed solid food two times a day and seven days a week. Note that the spiritually supportive environment can be conveyed through a specific webpage and the requirement of performing the declaration.

The community platform 10 further comprises a communication center 12 for the supporter 20 directly communicating with the designated recipient through Internet. As mentioned earlier, the communication center 12 is expected to impart a positive rehabilitative effect to the designated recipient 41 (i.e. the child having autism).

The financial center 60 comprises a charity record 61 for each of the designated recipients 41 to show the financial transactions made by the supporters 20 and the affiliate commissions contributed from the participating merchants 30.

The community platform 10 further contains an advertisement zone 13 for the participating merchant 30 to post an advertisement thereat, such that the advertisement of the participating merchant 30 is shown on the community platform 10 every time when the supporters 20 and designated recipients 41 access the community platform 10 through Internet. The community platform, which is preferably embodied as a website, allows posting of advertisements on the advertisement zone 13.

As an illustration, suppose that a particular participating merchant 30 pays 5% of affiliate commission to the designated recipient 41, the total income of the affiliate commission are as follows (for a particular supporter 20 and his family and relatives):

| | Affiliate |
|---|---|
| Spending | Commission (5%) |
| Family of autistic child (supporting their own fundraiser): | $900 × 0.05 = $45 |
| Family spending - $ 900 grocery/month | |
| Father: recruited 3 supporters 20 (who each spends $900 on | $2700 × 0.05 = $135 |
| groceries/month) | |
| 3 × $900 grocery/month = $2700 | |
| Mother: recruited 5 supporters 20: 5 × $900 = $4500 | $4500 × 0.05 = $225 |
| Sister recruited 4 supporters 20: 4 × $900 = $3600 | $3600 × 0.05 = $180 |
| Family: recruited additional 4 supporters 20: 4 × $900 = $3600 | $3600 × 0.05 = $180 |
| TOTAL AFFILIATE COMMISSION (from 17 supporters) | $765 |

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A financial donation method, comprising the steps of:
(a) providing a community platform for interactively linking among a plurality of supporters, a plurality of participating merchants, and a plurality of membership recipients with special needs, wherein each of said supporters is able to select one or more membership recipients as a designated recipient;
(b) voluntarily changing a living habit of each of said supporters to have a financial transaction with one of said participating merchants; and
(c) contributing a predetermined amount of affiliate commissions, based on an amount of said financial transaction, from said participating merchant to said designated recipient through said community platform.

2. The method as recited in claim 1 wherein, in the step (c), said designated recipient receives 100% of said affiliate commissions from said participating merchant such that said community platform make no profit from said affiliate commissions while said supporters participate in cashless charity.

3. The method, as recited in claim 1, wherein the step (a) further comprises a step of creating a spiritually supportive environment in said community platform by said designated recipient to make a declaration of a goal for self-improvement and inspiration, and an effort being undertaken, such that said designated recipient receives a special prize from at least one of said participating merchants and said supporters when said goal and effort are made.

4. The method, as recited in claim 2, wherein the step (a) further comprises a step of creating a spiritually supportive environment in said community platform by said designated recipient to make a declaration of a goal for self-improvement and inspiration, and an effort being undertaken, such that said designated recipient receives a special prize from at least one of said participating merchants and supporters when said goal and effort are made.

5. The method, as recited in claim 3, wherein said supporters are divided into a group of registered supporters who are willing to financially contribute to said membership recipients through financial transactions with said participating merchants and are registered with said community platform, and a group of general supporters who are not registered with said community platform yet are willing to financially contribute to said membership recipients, wherein only said registered supporters are able to designate a particular membership recipient as said designated recipient.

6. The method, as recited in claim 4, wherein said supporters are divided into a group of registered supporters who are willing to financially contribute to said membership recipients through financial transactions with said participating merchants and are registered with said community platform, and a group of general supporters who are not registered with said community platform yet are willing to financially contribute to said membership recipients, wherein only said registered supporters are able to designate a particular membership recipient as said designated recipient.

7. The method, as recited in claim 1, wherein the step (a) further comprises a step of providing a communication center for said supporter communicating with said designated recipient through Internet.

8. The method, as recited in claim 6, wherein the step (a) further comprises a step of providing a communication center for said supporter communicating with said designated recipient through Internet.

9. The method, as recited in claim 1, further comprising a step of creating a charity record for each of said designated recipients to show said financial transactions made by said supporters and said affiliate commissions contributed from said participating merchants.

10. The method, as recited in claim 8, further comprising a step of creating a charity record for each of said designated recipients to show said financial transactions made by said supporters and said affiliate commissions contributed from said participating merchants.

11. The method, as recited in claim 1, wherein the step (c) further comprises a step of paying a predetermined amount of advertising fee from said participating merchant to said community platform such that a corresponding advertisement of said participating merchant is shown on said community platform every time when said supporters and designated recipients access said community platform through Internet.

12. The method, as recited in claim 10, wherein the step (c) further comprises a step of paying a predetermined amount of advertising fee from said participating merchant to said community platform such that a corresponding advertisement of said participating merchant is shown on said community platform every time when said supporters and designated recipients access said community platform through Internet.

13. The method, as recited in claim 1, wherein said designated recipient is an autistic child or a family having an autistic child such that said special needs is defined as having suffered from autism.

14. The method, as recited in claim 12, wherein said designated recipient is an autistic child or a family having an autistic child such that said special needs is defined as having suffered from autism.

15. A financial donation system, comprising:
a community platform for interactively linking among said supporters, a plurality of participating merchants, and a plurality of membership recipients with special needs through Internet, wherein said community platform comprises a designated forum for each of said supporters to select one or more membership recipients as a designated recipient;
a charity database containing information of said participating merchants for said supporters to overview thereof to encourage each of said supporters to voluntarily change a living habit of said supporter to have a financial transaction with one of said participating merchants as a designated merchant; and
a financial center receiving a predetermined amount of affiliate commissions, based on an amount of said financial transaction, from said participating merchant to said designated recipient through said community platform.

16. The financial donation system, as recited in claim 15, wherein said financial center manages said affiliate commissions to directly deposit 100% of said affiliate commissions to said designated recipient in such a manner that said supporters participate in cashless charity.

17. The financial donation system, as recited in claim 15, wherein said community platform further comprises a spiritually supportive environment created by said designated recipient to make a declaration of a goal for self-improvement and inspiration, and an effort being undertaken, such that said designated recipient receives a special prize from at least one of said participating merchants and said supporters when said goal and effort are made.

18. The financial donation system, as recited in claim 16, wherein said community platform further comprises a spiritually supportive environment created by said designated recipient to make a declaration of a goal for self-improvement and inspiration, and an effort being undertaken, such that said designated recipient receives a special prize from at least one of said participating merchants and said supporters when said goal and effort are made.

19. The financial donation system, as recited in claim 15, wherein said community platform further comprises a communication center for said supporter communicating with said designated recipient through Internet.

20. The financial donation system, as recited in claim 18, wherein said community platform further comprises a communication center for said supporter communicating with said designated recipient through Internet.

21. The financial donation system, as recited in claim 15, wherein said financial center comprises a charity record for each of said designated recipients to show said financial transactions made by said supporters and said affiliate commissions contributed from said participating merchants.

22. The financial donation system, as recited in claim 20, wherein said financial center comprises a charity record for each of said designated recipients to show said financial transactions made by said supporters and said affiliate commissions contributed from said participating merchants.

23. The financial donation system, as recited in claim 15, wherein said community platform further comprises an advertisement zone for said participating merchant to post an advertisement thereat, such that said advertisement of said participating merchant is shown on said community platform every time when said supporters and designated recipients access said community platform through Internet.

24. The financial donation system, as recited in claim 22, wherein said community platform further comprises an advertisement zone for said participating merchant to post an advertisement thereat, such that said advertisement of said participating merchant is shown on said community platform every time when said supporters and designated recipients access said community platform through Internet.

25. The financial donation system, as recited in claim 15, wherein said designated recipient is registered to said community platform that said designated recipient is an autistic child or a family having an autistic child, wherein said special need is defined as having suffered from autism.

26. The financial donation system, as recited in claim 24, wherein said designated recipient is registered to said community platform that said designated recipient is an autistic child or a family having an autistic child, wherein said special need is defined from having suffered from autism.
